(19) United States
(12) Patent Application Publication
(10) Pub. No.: US 2023/0302856 A1
(43) Pub. Date: Sep. 28, 2023

(54) PNEUMATIC TIRE

(71) Applicant: KUMHO TIRE CO., INC., Gwangju (KR)

(72) Inventors: Woo-young KIM, Gwangju (KR); Byung Chul PARK, Gwangju (KR)

(21) Appl. No.: 18/185,182

(22) Filed: Mar. 16, 2023

(30) Foreign Application Priority Data
Mar. 22, 2022 (KR) 10-2022-0035626

(51) Int. Cl. B60C 15/00; B60C 15/02

(52) U.S. Cl. CPC B60C 15/0081; B60C 15/02

(57) ABSTRACT

A pneumatic tire to be combined with a rim is proposed. The tire may include a bead for preventing the pneumatic tire from coming off the rim. The tire may also include an apex configured to absorb an impact applied to the bead. The tire may further include a carcass extending to surround a portion of the apex and including a steel cord. The carcass may include a first carcass end portion disposed closer to one end of both ends of the apex in a radial direction of the pneumatic tire which is connected to the bead than the other end of the apex spaced apart from the bead.

### CROSS-REFERENCE TO RELATED APPLICATION

This application is based on and claims priority from Korean Patent Application No. 10-2022-0035626, filed on Mar. 22, 2022, the disclosure of which is incorporated herein in its entirety by reference for all purposes.

### TECHNICAL FIELD

The present disclosure relates to a pneumatic tire.

### BACKGROUND

In general, a vehicle can drive through pneumatic tires that rotate while being in contact with the road surface. The pneumatic tire includes a tread which contacts the road surface, a carcass which forms the skeleton of the tire, a belt capable of dispersing impact applied from the road surface, and a bead which provides a part where the pneumatic tire is coupled to a rim.

### SUMMARY

One embodiment of the present disclosure provides a pneumatic tire that improves durability and running performance of the pneumatic tire by maintaining the turn-up of a steel carcass without a separate member.

In addition, one embodiment of the present disclosure provides a pneumatic tire having a reduced rolling resistance and a reduced weight.

In accordance with an aspect of the present disclosure, there is provided a pneumatic tire to be combined with a rim, the pneumatic tire including: a bead for preventing the pneumatic tire from coming off the rim; an apex configured to absorb an impact applied to the bead; and a carcass extending to surround a portion of the apex and including a steel cord, wherein the carcass includes a first carcass end portion disposed closer to one end of both ends of the apex in a radial direction of the pneumatic tire which is connected to the bead than the other end of the apex spaced apart from the bead.

The first carcass end portion may be disposed at a position to satisfy following Equation 1: (⅗×A)<B<(½×C), where A is a distance between both ends of the bead in the radial direction, B is a distance from the one end of the apex connected to the bead to an end of the first carcass end portion in the radial direction, and C is a distance between both ends of the apex in the radial direction.

The apex may be configured such that a distance between both ends of the apex in the radial direction is greater than 5 and less than 45 mm.

A diameter of the steel cord may range from 0.09 mm to 0.15 mm.

The pneumatic tire may have a cross-sectional width of 205 mm to 275 mm and an aspect ratio of 40% to 55%.

According to one embodiment of the present disclosure, the durability and running performance of the pneumatic tire can be improved by maintaining the turn-up of the steel carcass without a separate member.

Moreover, according to one embodiment of the present disclosure, the rolling resistance of the tire can be reduced, and the weight of the tire can be reduced.

### BRIEF DESCRIPTION OF THE DRAWINGS

FIG. 1 is a cross-sectional view showing a pneumatic tire according to one embodiment of the present disclosure.

FIG. 2 is a partially enlarged view of FIG. 1.

FIG. 3 is a partially enlarged view of FIG. 1.

FIG. 4 is a diagram showing analysis results of Example of the present disclosure and Comparative Examples 2, 4 and 5.

FIG. 5 is a view showing the results of strain energy analysis at the end of the carcass of Example of the present disclosure and Comparative Examples 2, 4 and 5.

### DETAILED DESCRIPTION

Pneumatic tires have various sizes and shapes, and may be classified into PCR tires (passenger car radial tires) and TBR tires (truck bus radial tires) according to the types of vehicles in which the tires are used.

Meanwhile, the carcass serves as the skeleton of the pneumatic tire, and different types of carcasses are used according to the required performances of the tires. In particular, conventionally, a fabric carcass has been mainly used in the PCR tires, and a steel carcass has been mainly used in the TBR tires to withstand high weight.

However, in recent years, the steel carcass is also used in the PCR tires to withstand high weight and high torque. When the steel carcass is applied to a PCR tire, there may occur a phenomenon in which in a turn-up process of raising the carcass through beads, the turn-up is loosened. In addition, when a separate member for maintaining the turn-up of the carcass is provided, there is a problem in that the rolling resistance performance of the tire is deteriorated and the tire weight is increased.

Accordingly, there is a demand to provide a pneumatic tire that can reduce the rolling resistance of the tire and reduce the weight of the tire while maintaining the turn-up of the steel carcass without a separate member to improve the durability and running performance of the pneumatic tire

Hereinafter, a configuration and operation according to an embodiment of the present disclosure will be described in detail with reference to the accompanying drawings.

Further, in describing the present disclosure, detailed descriptions of known configurations or functions may be omitted to clarify the present disclosure.

When an element is referred to as being ‘connected’ to another element, it should be understood that the element may be directly connected to or transferred to the other element, but that other elements may exist in the middle.

The terms used in the present disclosure are only used for describing specific embodiments, and are not intended to limit the present disclosure. Singular expressions include plural expressions unless the context clearly indicates otherwise.

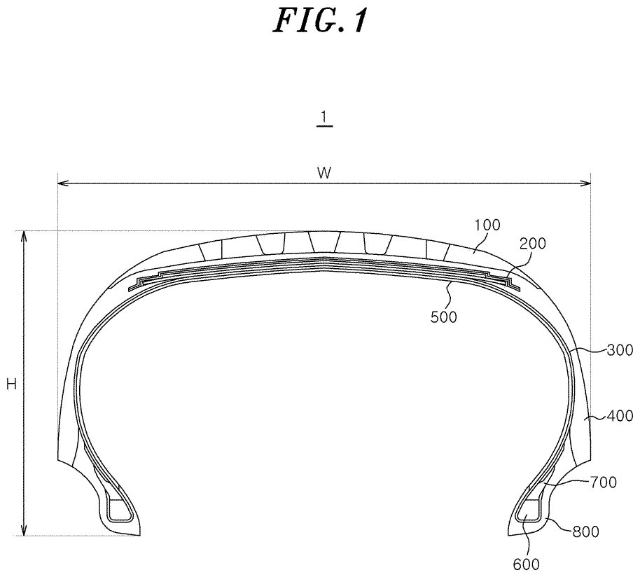

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added. The ‘radial direction’ described below refers to the radial direction of the tire and the up-down direction in FIG. 1, and the ‘axial direction’ refers to a direction perpendicular to the radial direction and parallel to the rotational axis of the tire, and the left and right direction in FIG. 1. Accordingly, in FIG. 1, the outer side in the radial direction means the upper side, the inner side in the radial direction means the lower side, the outer side in the axial direction means the right side, and the inner side in the axial direction means the left side. Meanwhile, unless otherwise specified, the directions include both positive and negative directions. In addition, ‘width’ means a width in the axial direction, and ‘height’ means a height in the radial direction.

Hereinafter, a specific configuration of a pneumatic tire 1 according to one embodiment of the present disclosure will be described with reference to the drawings.

Referring to FIG. 1, the pneumatic tire 1 according to one embodiment of the present disclosure may be mounted to a vehicle and may contact the ground. The pneumatic tire 1 may have different cross-sectional widths W, aspect ratios, and tire diameters depending on the type. For example, the pneumatic tire 1 may have a cross-sectional width W of 205 mm to 275 mm inclusive. In this specification, the cross-sectional width W of the pneumatic tire 1 means the distance from one side to the other side in the axial direction.

In addition, the pneumatic tire 1 may have an aspect ratio of 40% to 55% inclusive. In this specification, the aspect ratio of the pneumatic tire 1 may be defined as (cross-sectional height H)/(cross-sectional width W)×100%. Further, the pneumatic tire 1 may have a diameter of 16 to 20 inches inclusive.

Meanwhile, the pneumatic tire 1 may include a tread 100, a belt 200, a carcass 300, a sidewall 400, an inner liner 500, a bead 600, an apex 700, and a rim flange coupling part 800.

The tread 100 is disposed on the outermost side of the pneumatic tire 1 and may be in direct contact with the ground. A plurality of grooves may be provided on an outer circumferential surface of the tread 100 to adjust driving force, braking force or turning force of the pneumatic tire 1. In addition, the grooves may be provided to be depressed by a predetermined depth from the outer circumferential surface of the tread 100. The grooves may have shapes of various patterns suitable for the use of the pneumatic tire 1.

The belt 200 is disposed between the tread 100 and the carcass 300 and can disperse an impact applied to the tread 100 from the outside. The belt 200 may be located at an inner side of the tread 100 in the radial direction and an outer side of the carcass 300 in the radial direction. In addition, the belt 200 may be formed of one or two layers. For example, when the belt 200 is formed of two layers, the two layers may be stacked one on another in the radial direction.

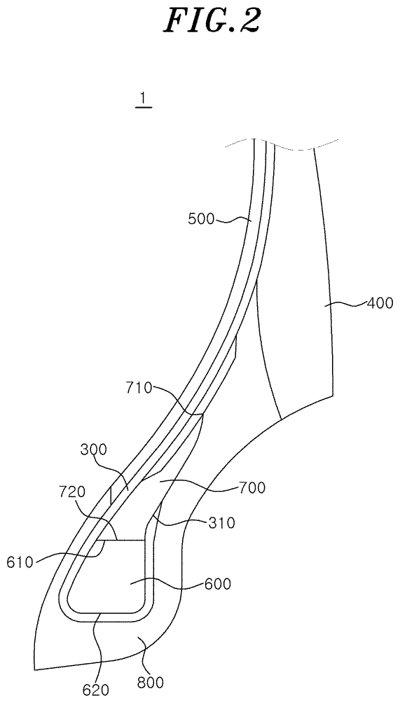

Referring to FIG. 2, the carcass 300 may be provided to form a skeleton of the pneumatic tire 1. The carcass 300 indicates a cord layer inside the pneumatic tire 1, and since the carcass 300 serves to support a load and absorb shock, it may be formed of a material that is resistant to fatigue against flexion and extension movements. For example, the carcass 300 may include a plurality of steel cords. Since the steel cord has a high modulus and a low change in physical properties due to heat and moisture, the rolling resistance of the pneumatic tire 1 can be reduced. In addition, the steel cord included in the carcass 300 may have a diameter of 0.09 mm to 0.15 mm inclusive. Moreover, the steel cord may have a cutting force of 25 kgf to 86 kgf inclusive.

Meanwhile, the carcass 300 may be located at an inner side of the belt 200 in the radial direction and an outer side of the inner liner 500 in the radial direction. The carcass 300 may form one layer. Here, the carcass 300 forming one layer means that the carcass 300 is formed of one layer rather than a plurality of layers separated in the radial direction. In addition, the carcass 300 may be turned up to surround the bead 600 and the apex 700. In this specification, turning up of the carcass 300 means that the carcass 300 extending toward the inner side in the radial direction is bent and extended toward the outer side in the radial direction to surround the bead 600 and the apex 700. In this case, the carcass 300 may be extended in a ‘u’ shape to surround the bead 600 and the apex 700. The carcass 300 may have a first carcass end portion 310.

The first carcass end portion 310 may be one end portion of the carcass 300 located on the side of the bead 600 and the apex 700. The first carcass end portion 310 may be interposed between the bead 600 and the rim flange coupling part 800 to surround the bead 600. In addition, the first carcass end portion 310 may be disposed between the apex 700 and the rim flange coupling part 800 to surround a portion of the apex 700. In this case, a portion of the apex 700 may contact the rim flange coupling part 800. Further, the first carcass end portion 310 may have a thickness which becomes thinner from the inner side in the radial direction to the outer side in the radial direction. In other words, in FIG. 2, the thickness of the first carcass end portion 310 may become thinner from the lower side to the upper side.

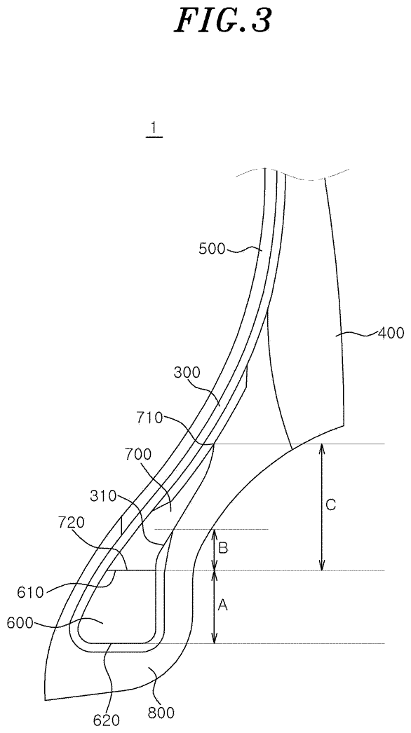

Referring to FIG. 3, the first carcass end portion 310 may be disposed closer to a second apex end 720 than a first apex end 710 of the apex 700. For example, the first carcass end portion 310 may be disposed at a position to satisfy Equation 1 below.

(⅗×A)<B<(½×C) Equation 1

In Equation 1, A indicates a distance between both ends of the bead 600 in the radial direction. In other words, A in Equation 1 indicates a distance between a first bead end 610 and a second bead end 620 to be described later in the radial direction as shown in FIG. 3. Further, in Equation 1, B indicates a distance from the second apex end 720 to an end of the first carcass end portion 310 in the radial direction. Furthermore, in Equation 1, C indicates a distance between both ends of the apex 700 in the radial direction. In other words, C in Equation 1 indicates a distance between the first apex end 710 and the second apex end 720 in the radial direction as shown in FIG. 3.

The sidewall 400 may be provided on both sides along the axial direction of the pneumatic tire 1 with respect to the tread 100 to protect the side surfaces of the tire. The outer side of the sidewall 400 in the radial direction is connected to the tread 100, and the inner side of the sidewall 400 in the radial direction may be formed to surround the bead 600. The sidewall 400 may be made of a cross-linked rubber having excellent light resistance.

The inner liner 500 may be provided to maintain the pressure of air filled inside the pneumatic tire 1. In other words, the inner liner 500 may prevent the air in the pneumatic tire 1 from leaking out. The inner liner 500 may be disposed at the innermost side of the pneumatic tire 1 and may be made of an impermeable material. For example, the inner liner 500 may be made of butyl rubber of high-density, or the like.

The bead 600 may provide rigidity for fixing the pneumatic tire 1 to a rim (not shown). The bead 600 may include one or more wires, cords, cores, and the like. For example, the bead 600 may be formed of a bundle of steel wires. The bead 600 may have the first bead end 610 and the second bead end 620.

The first bead end 610 is one of both ends of the bead 600 in the radial direction connected to the apex 700. In addition, the second bead end 620 is the other one of both ends of the bead 600 in the radial direction spaced apart from the apex 700.

The apex 700 may support the rigidity of the bead 600 itself, and absorb impact. The apex 700 may enhance riding comfort and steering stability by absorbing impact applied to the bead 600 while a vehicle drives. Further, the apex 700 may be located at an outer side of the bead 600 in the radial direction. A part of a peripheral portion of the apex 700 may be covered by the carcass 300. Meanwhile, the apex 700 may include the first apex end 710 and the second apex end 720.

The first apex end 710 is one of both ends of the apex 700 in the radial direction spaced apart from the bead 600. In other words, the first apex end 710 is one radial end of the apex 700, which is spaced apart from the first bead end 610.

The second apex end 720 is one of both ends of the apex 700 in the radial direction connected to the bead 600. In other words, the second apex end 720 is other radial end of the apex 70, which is connected to the first bead end 610.

A distance between the first apex end 710 and the second apex end 720 in the radial direction may be greater than 5 mm and less than 45 mm.

The rim flange coupling part 800 may provide a portion where the pneumatic tire 1 is coupled to the rim. In addition, the rim flange coupling part 800 can prevent the pneumatic tire 1 from coming off the rim.

As described above, the pneumatic tire 1 according to one embodiment of the present disclosure can maintain the turn-up position of the carcass 300 while using the steel cord by adjusting the end position of the carcass 300.

Moreover, the pneumatic tire 1 according to one embodiment of the present disclosure can reduce the weight of the pneumatic tire 1 and the rolling resistance while using the steel cord.

Hereinafter, the effect of the pneumatic tire 1 according to one embodiment of the present disclosure described above will be described in detail in comparison with comparative examples.

TABLE 1

| | | Compar- | Compar- | |
|---|---|---|---|---|
| | | ative | ative | |
| Item | | Example 1 | Example 2 | Example |
| Carcass | | PET1300D/ | Steel | Steel |
| | | 2P | 2 + 7*0.095 | 2 + 7*0.095 |
| Cord cutting force (kgf) | | 20.2 | 25.5 | 25.5 |
| Number of carcass layers | | 2 layers | 1 layer | 1 layer |
| A (mm) | | 8 | 8 | 8 |
| B (mm) | | 7 | 30 | 7 |
| B′ (mm) | | 30 | — | — |
| C (mm) | | 15 | 15 | 15 |
| Tire weight (Index) | | 100 | 94 | 92 |
| Rolling resistance (Index) | | 100 | 103 | 110 |
| NVH | 400 Hz Peak level | 0 | −1.4 | −4.2 |
| (Noise | O/A | 0 | −1.0 | −1.5 |
| dB) | Booming | 0 | −0.7 | −0.9 |
| | Cavity noise | 0 | −1.6 | −2.1 |
| | Rumble | 0 | −1.3 | −2.5 |

As shown in Table 1 above, Example of the present invention has an effect of reduced weight, improved rolling resistance performance, and reduced noise compared to Comparative Example 1 in which the carcass includes a fiber cord and two carcass layers. In addition, Example of the present invention has an effect of reduced weight, improved rolling resistance, and reduced noise compared to Comparative Example 2 in which the turn-up of the carcass 300 is formed at an excessively high position and does not satisfy Equation 1. In the above Table 1, 400 Hz Peak level means peak noise in the 400 Hz range, and O/A means overall noise.

TABLE 2

| | | Compar- | Compar- | |
|---|---|---|---|---|
| | | ative | ative | |
| Item | | Example 1 | Example 3 | Example |
| Carcass | | PET1300D/ | PET1300D/ | Steel |
| | | 2P | 2P | 2 + 7*0.095 |
| Number of carcass layers | | 2 layers | 1 layer | 1 layer |
| A (mm) | | 8 | 8 | 8 |
| B (mm) | | 7 | 30 | 7 |
| B′ (mm) | | 30 | — | — |
| C (mm) | | 15 | 15 | 15 |
| Tire weight (Index) | | 100 | 87 | 92 |
| Rolling resistance (Index) | | 100 | 109 | 110 |
| Force & Moment | CC (1°) | 100 | 89 | 103 |
| (Index) | ATC (1°) | 100 | 90 | 102 |
| Driving | Ride | 100 | 95 | 101 |
| performance | Handling | 100 | 92 | 105 |
| sentiment | Noise | 100 | 97 | 102 |
| evaluation | | | | |
| result (Index) | | | | |

As shown in Table 2 above, comparing Comparative Example 1 and Comparative Example 3, when the number of fiber carcass plies is reduced from two to one, weight and rolling resistance are improved, but Force & Moment is reduced due to the decrease in stiffness of the side part. In contrast, in Example of the present disclosure, by using a single layer steel carcass, not only the weight and rolling resistance are improved, but also the stiffness of the side part is improved, so that improved driving performance can be obtained.

TABLE 3

| | | Compar- | Compar- | |
|---|---|---|---|---|
| | | ative | ative | |
| Item | | Example 1 | Example 2 | Example |
| Carcass | | PET1300D/ | Steel 2 + | Steel 2 + |
| | | 2P | 7*0.095 | 7*0.095 |
| Number of carcass layers | | 2 layers | 1 layer | 1 layer |
| A (mm) | | 8 | 8 | 8 |
| B (mm) | | 7 | 30 | 7 |
| B′ (mm) | | 30 | — | — |
| C (mm) | | 15 | 15 | 15 |
| Number of evaluation samples | | 90 samples | 90 samples | 90 samples |
| Bad air wrap | 1 day neglect | 0% | 6.6% (2) | 0% |
| incidence | (30 samples) | | | |
| rate by | 3 days neglect | 0% | 16.6% (5) | 0% |
| green case | (30 samples) | | | |
| neglect time | 5 days neglect | 0% | 23.3% (7) | 3% (1) |
| | (30 samples) | | | |

As shown in Table 3 above, when the end of the carcass 300 is turned up to a position higher than the apex 700 as in Comparative Example 2, the defect rate is 13 times higher than the typical tire manufacturing defect rate of 0.5%. It can be confirmed that the defect rate increases as the green case is left alone (neglected) for longer. As such, in Example of the present disclosure, the end of the carcass 300 is turned up to satisfy Equation 1, which maintains the same defect rate as the fiber carcass of Comparative Example 1 to secure the manufacturing yield.

TABLE 4

| | Comparative | Comparative | Comparative | |
|---|---|---|---|---|
| Item | Example 2 | Example 4 | Example 5 | Example |
| Carcass ply | Steel 2 + | Steel 2 + | Steel 2 + | Steel 2 + |
| | 7*0.095 | 7*0.095 | 7*0.095 | 7*0.095 |
| Number of | 1 layer | 1 layer | 1 layer | 1 layer |
| carcass layers | | | | |
| A (mm) | 8 | 8 | 8 | 8 |
| B (mm) | 30 | 18 | 0 | 7 |
| C (mm) | 15 | 15 | 15 | 15 |
| Rolling resistance | 90 | 96 | 100 | 100 |
| (Index) | | | | |
| Bead load | 100 | 110 | 60 | 120 |
| durability (Index) | | | | |
| Speed durability | 100 | 110 | 100 | 110 |
| (Index) | | | | |
| Incision analysis | Failure | No Failure | Failure | No Failure |
| after LTDE | | | | |
| Strain Energy | 100 | 90 | 85 | 77 |
| (Index) | | | | |

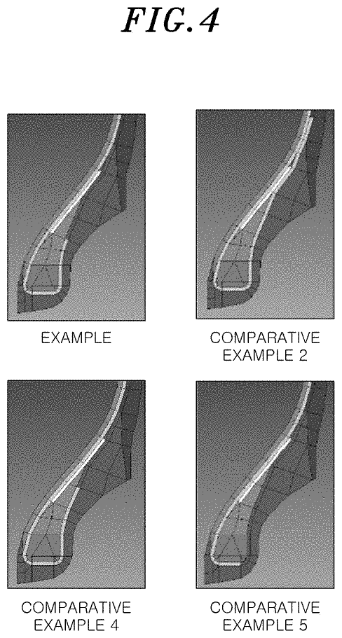

Referring to Table 4 above and FIG. 4, when the carcass 300 was turned up to an excessively high position as in Comparative Example 2, the carcass 300 was damaged as a result of incision analysis after long term durability (LTDE). In addition, as in Comparative Example 4, when the carcass 300 was turned up to a slightly higher position than in Example of the present disclosure, the rolling resistance performance was deteriorated, and as in Comparative Example 5, when the carcass 300 was turned up to the bead 600, the incision analysis after LTDE revealed that the carcass 300 was damaged.

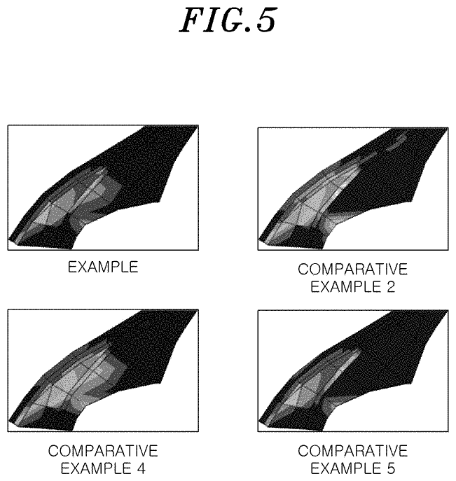

In addition, referring to Table 4 above and FIG. 5, Example of the present disclosure has an effect of reducing strain energy at the end of the carcass 300 compared to Comparative Examples 2, 4, and 5.

TABLE 5

| | Comparative | Comparative | Comparative | Comparative | |
|---|---|---|---|---|---|
| Item | Example 6 | Example 7 | Example 8 | Example 9 | Example |
| Carcass ply | 2 + 7*0.095 | 2 + 7*0.095 | 2 + 7*0.095 | 2 + 7*0.095 | 2 + 7*0.095 |
| A (mm) | 8 | 8 | 8 | 8 | 8 |
| B (mm) | 2.5 | 5 | 15 | 15 | 7 |
| C (mm) | 5 | 10 | 30 | 45 | 15 |
| Rolling resistance (Index) | 99 | 101 | 98 | 90 | 100 |
| Handling (Index) | 92 | 99 | 103 | 100 | 100 |
| Bead load durability | 95 | 99 | 98 | 80 | 100 |
| (Index) | | | | | |

Referring to Table 5 above, as in Comparative Example 6, when the length C of the apex 700 in the radial direction is 5 mm, the handling performance is rapidly reduced and the bead load durability is also reduced. In addition, as in Comparative Example 9, when the length C of the apex in the radial direction was 45 mm, the rolling resistance (RR) decreased and the bead durability rapidly decreased. As such, it can be seen that when the length C of the apex 700 in the radial direction is greater than 5 mm and less than 45 mm, it is effective in improving rolling resistance performance, improving handling performance, and preventing reduction in bead load durability.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A pneumatic tire to be combined with a rim, the pneumatic tire comprising:
a bead configured to prevent the pneumatic tire from coming off the rim;
an apex configured to absorb an impact applied to the bead; and
a carcass extending to surround a portion of the apex and including a steel cord,
wherein the carcass includes a first carcass end portion disposed closer to one end of both ends of the apex in a radial direction of the pneumatic tire which is connected to the bead than the other end of the apex spaced apart from the bead.

2. The pneumatic tire of claim 1, wherein the first carcass end portion is disposed at a position to satisfy following Equation 1:
(⅗×A)<B<(½×C)
where A is a distance between both ends of the bead in the radial direction, B is a distance from the one end of the apex connected to the bead to an end of the first carcass end portion in the radial direction, and C is a distance between both ends of the apex in the radial direction.

3. The pneumatic tire of claim 1, wherein the apex is configured such that a distance between both ends of the apex in the radial direction is greater than 5 and less than 45 mm.

4. The pneumatic tire of claim 1, wherein a diameter of the steel cord ranges from 0.09 mm to 0.15 mm.

5. The pneumatic tire of claim 1, wherein the pneumatic tire has a cross-sectional width of 205 mm to 275 mm and an aspect ratio of 40% to 55%.
